(19) United States
(12) Patent Application Publication
(10) Pub. No.: US 2007/0205679 A1
(43) Pub. Date: Sep. 6, 2007

(54) Brushless Motor

(76) Inventors: Takahiro Terauchi, Kiryu-shi (JP); Chikahumi Sugai, Kiryu-shi (JP); Takeshi Yamazaki, Kiryu-shi (JP); Satoru Negishi, Kiryu-shi (JP)

Correspondence Address: KENYON & KENYON LLP, ONE BROADWAY, NEW YORK, NY, 10004, US

(21) Appl. No.: 11/578,400

(22) PCT Filed: Apr. 12, 2005
(86) PCT No.: PCT/JP05/07093

§ 371 Date: Oct. 12, 2006

(30) Foreign Application Priority Data
Apr. 15, 2004 (JP) 2004-120003

(51) Int. Cl. H02K 1/04; H02K 11/00

(52) U.S. Cl. 310/71; 310/68 B; 310/43; 310/89

(57) ABSTRACT

This brushless motor includes: stators respectively having wires and cores around which the wires are respectively wound; a housing which houses the stators; a rotor rotatably attached to the housing; and a bracket having conductive bodies to which terminal leading lines of the wires are respectively connected and an insulating body supporting the conductive bodies, and installed in an opening of the housing; wherein the conductive bodies are insert-molded to the insulating body.

### CROSS-REFERENCE TO RELATED APPLICATIONS

This application is a National Phase Application of PCT/JP2005/006969 filed on Apr. 8, 2005, which claims priority to Japanese Patent Application No. 2004-120003, filed Apr. 15, 2004, the content of each of which is incorporated herein by reference.

### BACKGROUND ART OF THE INVENTION

A brushless motor which causes a rotor having magnets to rotate by applying a current to a stator having a magnetic coil is known as a rotating electrical machine.

A bracket is installed in a housing in which the magnetic coil is housed so as to cover an opening of the housing. A terminal unit is attached to the bracket, and wind beginning ends and wind terminating ends of each phase wires which form the magnetic coils are connected to the terminal unit.

For example, the terminal unit includes a holder located so as to surround the rotor, and circular conductive bodies and insulating layers are alternatively stacked on the outer circumferential portion of a cylindrical portion of the holder.

Connection portions connected to the wind beginning ends and the wind terminating ends of the wires and the like are extended from the conductive bodies (for example, refer to PATENT DOCUMENT 1). Further, conductive bodies are respectively inserted in a number of grooves formed so as to be disposed in a concentric fashion, and connection terminal ends respectively extended from the conductive bodies are disposed at regular intervals (for example, refer to PATENT DOCUMENT 2).

Terminals to which the conductive bodies are respectively connected are disposed on the bracket. The terminals are connected to a coupler for power supply disposed on the bracket. In assembling of the brushless motor, when the bracket is installed in the housing, the conductive bodies of the terminal unit are respectively connected to the terminals of the bracket.
PATENT DOCUMENT 1: Japanese Patent Application, First Publication No. 2000-78272
PATENT DOCUMENT 2: Japanese Patent Application, First Publication No. 2002-171708

### DISCLOSURE OF THE INVENTION

### PROBLEMS TO BE SOLVED BY THE INVENTION

However, in this type of brushless motor, it is necessary to electrically connect the wind beginning ends of the wires and the like to the conductive bodies of the terminal unit, and it is necessary to electrically connect the terminals of the bracket to the conductive bodies of the terminal unit. As a result, it is hard to perform installation of the brushless motor in a time-efficient manner.

Further, in the terminal unit, since it is necessary that conductive bodies and insulating layers be alternatively stacked, it is hard to shorten the length of the terminal unit along an axial direction of the terminal unit. As a result, it is impossible to downsize the brushless motor.

The present invention was conceived in view of the above-described circumstances, and it is an object of the present invention to provide a small and high-performance brushless motor which allows for efficient assembling.

### MEANS FOR SOLVING THE PROBLEM

The present invention provides a brushless motor including: stators respectively having wires and cores around which the wires are respectively wound; a housing which houses the stators; a rotor rotatably attached to the housing; and a bracket having conductive bodies to which terminal leading lines of the wires are respectively connected and an insulating body supporting the conductive bodies, and installed at an opening of the housing; wherein the conductive bodies are insert-molded to the insulating body.

According to the brushless motor of the present invention, conductive bodies connected to the terminal leading lines are integrated with the insulating body. Since the conductive bodies are insulated by the insulating body which forms the bracket, the brushless motor becomes compact. In addition, while installing the brushless motor, the need for connecting the conductive bodies to the bracket is eliminated.

The brushless motor of the present invention may be arranged such that the through-holes which pass through the bracket from the inside surface facing to the housing toward the outside surface facing in the opposite direction to the inside surface are formed in the bracket, the terminal leading lines are respectively inserted into the through-holes from the inside surface, and the terminal leading lines are respectively fixed to the conductive bodies at the outside surface of the bracket.

According to the brushless motor of the present invention, the terminal leading lines are respectively inserted in the through-holes from the inside toward the outside of the brushless motor, and then are respectively connected to the conductive bodies. Therefore, after installing of the bracket to the housing, the terminal leading lines can be connected to the conductive bodies at the outside of the brushless motor.

The brushless motor of the present invention may be arranged such that the through-holes are elongated holes formed so as to be along the circumferential direction of the bracket, and the conductive bodies are respectively provided with connection portions respectively protruding into the through-holes so as to cover in a part of the through-hole.

According to the brushless motor of the present invention, since a part of the conductive body is exposed at each of the elongated holes, each of the terminal leading lines is pulled out through a gap formed between an edge of the elongated hole and the conductive body. Therefore, the terminal leading lines are respectively connected to the conductive bodies.

The brushless motor of the present invention may be arranged such that notches respectively engaged with the terminal leading lines are respectively formed in the connection portions along the circumferential direction of the bracket.

According to the brushless motor of the present invention, the terminal leading lines respectively inserted in the through-holes are moved along the circumferential direction of the bracket, and thereby the terminal leading lines can be respectively engaged with the notches respectively disposed on the connection portions. As a result, it is possible to connect the terminal leading lines to the connection portions easily.

The brushless motor of the present invention may be arranged such that the conductive bodies are respectively connected to terminal ends of a coupler for energization which is extended from a side portion of the bracket.

According to the brushless motor of the present invention, since the conductive bodies integrated with the bracket are respectively connected to the terminal ends of the coupler, it eliminates the need for conventional parts for connecting the conductive bodies to the coupler, and further eliminates the need for a process of connecting the conductive bodies to the coupler.

### ADVANTAGEOUS EFFECTS OF THE INVENTION

According to the present invention, since the bracket is manufactured by performing the insert molding of the conductive bodies to which the terminal leading lines of the wires of the magnetic coils are respectively connected to the insulating body, it is possible to simplify the structure of the brushless motor, and it is possible to downsize the brushless motor. Further, by installing the bracket in the housing, the conductive bodies can be located in place, and can be fixed in place. As a result, the assembling of the brushless motor becomes efficient.

### BRIEF DESCRIPTION OF THE DRAWINGS

FIG. 1 is a view showing an embodiment of a brushless motor of the present invention, and is a sectional view showing the brushless motor which is taken apart.

FIG. 2 is a sectional view showing the brushless motor.

FIG. 3 is a view showing the bracket while looking at the bracket along a direction of arrow A in FIG. 1, and shows the position of the terminals.

FIG. 4 is a view showing the bracket while looking at the bracket along a direction of arrow A in FIG. 1.

FIG. 5 is a view showing the brushless motor while looking at the bracket along a direction of arrow B in FIG. 2, and shows a state where the terminal leading lines are respectively inserted in the through-holes.

FIG. 6 is a view showing the brushless motor while looking at the bracket along a direction of arrow B in FIG. 2, and shows a state where the terminal leading lines are respectively connected to the connection portions.

### DESCRIPTION OF THE REFERENCE SYMBOLS

1 . . . brushless motor, 2 . . . housing (stator), 2a . . . opening, 3 . . . rotor, 4 . . . bracket, 4a . . . inside surface, 4b . . . outside surface, 16 . . . core (stator), 15 . . . wire, 17 . . . terminal leading line, 35, 36 and 37 . . . terminals (conductive bodies), 42a, 42b and 42c . . . connection portions, 43 . . . notch, 45 . . . coupler, 46a, 46b and 46c . . . terminal ends, 47 . . . through-hole

### BEST MODE FOR CARRYING OUT THE INVENTION

A best mode for carrying out the present invention will be explained with reference to figures.

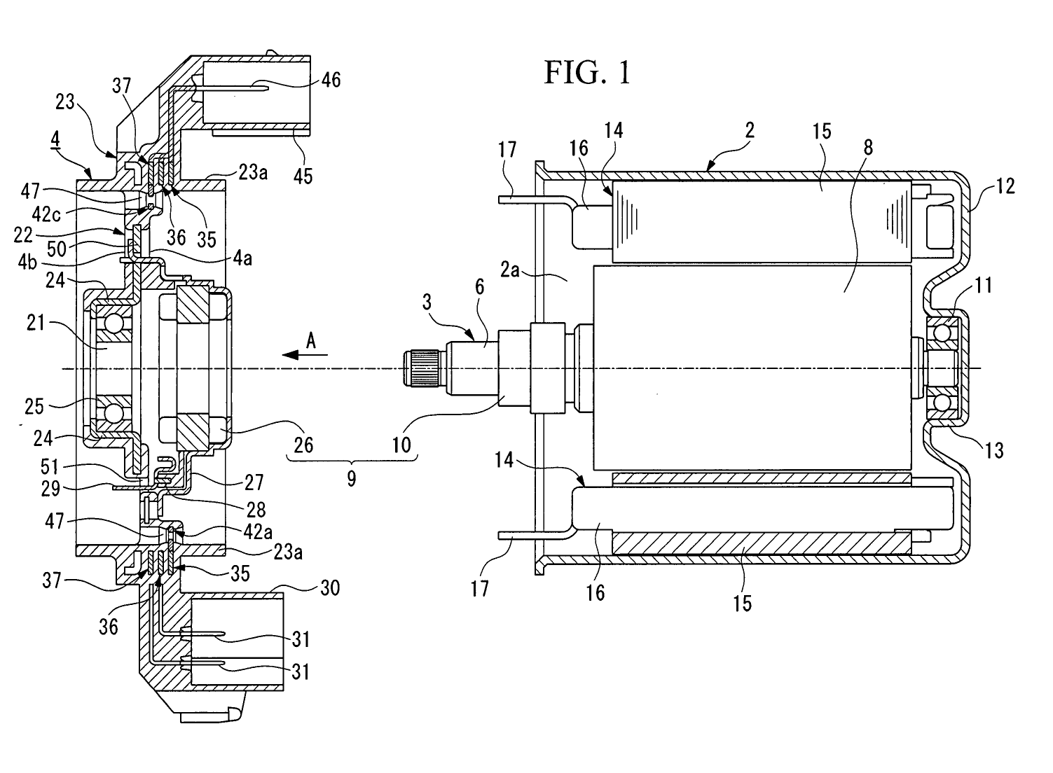

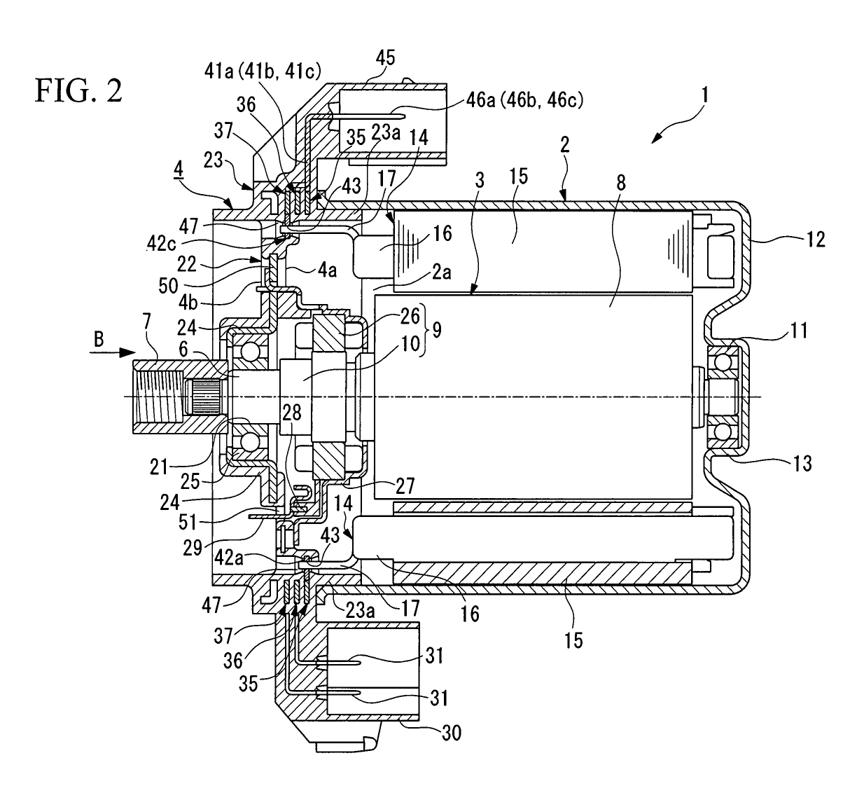

A best mode for carrying out the present invention will be explained with reference to figures. As shown in FIG. 1 and FIG. 2, a brushless motor 1 includes a housing 2, a rotor 3, and a bracket 4. The rotor 3 is inserted inside the housing 2 which is a cylindrical yoke having a bottom. The bracket 4 is attached to an opening 2a of the housing 2.

The rotor 3 has a rotation shaft 6. As shown in FIG. 2, a joint 7 which is connected to a rotation shaft of another device is pressed into the tip end of the rotation shaft 6. Magnets 8 are fixed to the terminal of the rotation shaft 6. The polarity of each of the magnets 8 differs, and the magnets 8 are alternatively disposed around the rotation shaft 6. A resolver rotor 10 which constructs a resolver 9 for detection of the rotation position is fixed to a part of the rotation shaft 8 which is closer to the tip end of the rotation shaft 6 than the magnet 8. The terminal end of the rotation shaft 6 is rotatably supported by a bearing 11.

The bearing 11 is pushed into a recessed portion 13 which is formed at the center of a bottom portion of the housing 2. Cores 16 such as iron cores are disposed inside the housing 2. Conductive wires 15 are respectively wound around the cores 16, thereby each of magnetic coils 14 is formed. The magnetic coils 14 are disposed inside the housing 2 so as to be placed opposite with respect to each of phases (U-phase, V-phase and W-phase) which turn on electricity. As shown in FIG. 1, the wind beginning end and wind terminating end (hereunder, so-called terminal leading line 17) of the wire 15 of the magnetic coils 14 are extended along a direction parallel to an axis of the brushless motor 1 so as to respectively protrude from the opening 2a of the housing.

The bracket 4 includes a base portion 22 like a substantially circular disc having an opening 21 which is formed in the center of the bracket 4. A side portion 23 of which the length along the axial direction is longer than the base portion 22 is disposed at an outer circumferential edge of the base portion 22. This bracket 4 is formed from insulating resin. A metal plate 24 is inserted inside the base portion 22. The plate 24 is substantially formed like a ring, and is bent along the axial direction after an end portion located at an inner circumferential side protrudes into the opening 21 of the base portion 22. A bearing 25 which rotatably supports the tip end of the rotor 3 is pushed into the inside of the bent portion of the plate 24.

In addition, a resolver case 27 for attaching a resolver stator 26 of the resolver 9 is attached to the base portion 22. Resolver terminals 28 of the resolver 9 are respectively connected to conductive bodies 29 attached to the bracket 4, and are respectively connected to terminals of a coupler 30.

In addition, an engaging portion 23a is disposed on the side portion 23 of the bracket 4, and an inner circumferential surface of the housing 2 and an end surface of the opening 2a are contacted to the engaging portion 23a. Further, three terminals 35, 36 and 37 such as conductive bodies are inserted inside the side portion 23 so as to be located at regular intervals along the axial direction.

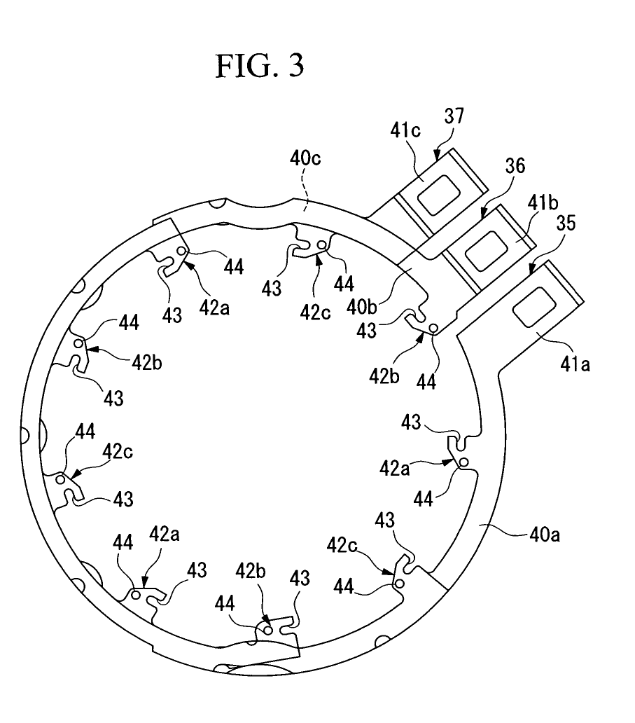

As shown in FIG. 3, the terminal 35 includes an arc-shaped main body 40a like a part cut off from a circle. An extended portion 41a is provided at an end of the main body 40a so as to protrude outward in the radial direction of the circle. Further, three connection portions 42a are provided at the inner circumferential side of the main body 40a so as to be located at regular intervals along the circumferential direction. Each of the connection portions 42a is formed so as to protrude toward a center axis. Notches 43 are respectively provided at the connection portions 42a so that the notches 43 are formed along the circumferential direction and face the same side. Recessed portions 44 are respectively formed in the connection portions 42a. The recessed portions 44 become operative when the terminal 35 is supported by a die while manufacturing the bracket 4.

The terminal 36 includes an arc-shaped main body 40b like a part cut off from a circle. An end of the main body 40b is located so as to be close to the end of the terminal 35. An extended portion 41b is provided at the end of the main body 40b so as to protrude outward in the radial direction of the circle. Further, three connection portions 42b are provided at the inner circumferential side of the main body 40b so as to be located at regular intervals. The shape of each of the connection portions 42b is the same as the connection portions 42a.

The terminal 37 includes an arc-shaped main body 40c like a part cut off from a circle. An end of the main body 40c is located so as to be close to the end of the terminal 36. An extended portion 41c is provided at the end of the main body 40c so as to protrude outward in the radial direction of the circle. Further, three connection portions 42c are provided at the inner circumferential side of the main body 40c so as to be located at regular intervals. The shape of each of the connection portions 42c is the same as the connection portions 42a.

Note that, the extended portions 41b and 41c are bent so that a tip end of each of the extended portions 41b and 41 is substantially parallel to the extended portion 41a. As shown in FIG. 2, the extended portions 41a, 41b and 41c are respectively connected to terminal ends 46a, 46b and 46c of a coupler 45 disposed on the side portion 23 of the bracket 4. A power cable is connected to the coupler 45, and then electric power is supplied to the coupler 45 from a three-phase electric power source.

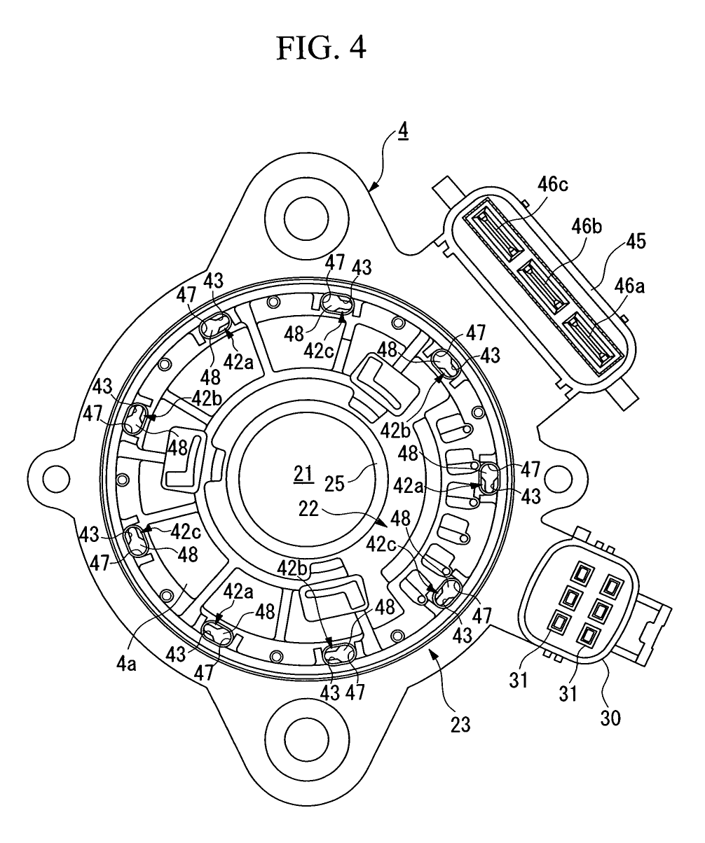

As shown in FIG. 3, a total of nine connection portions 42a, 42b and 42c are located at regular intervals so as to be disposed in connection portions 42a, 42b and 42c respectively. The main bodies 40a, 40b and 40c respectively formed with the terminals 35, 36 and 37 described above are housed in the side portion 23. Further, the connection portions 40a, 40b and 40c are located inside the base portion 23, as shown in FIG. 4, and parts of the connection portions 40a, 40b and 40c are respectively exposed at through-holes 47. The through-holes 47 are an elongated hole extending along the circumferential direction. The through-holes 47 are located at regular intervals along the circumferential direction, and a total of nine are formed. The connection portions 42a, 42b and 42c respectively formed with the terminals 35, 36 and 37 are provided so that each of connection portions 42a, 42b and 42c blocks a half area of each of the through-holes 47. Opening ends of the notches 43 respectively communicate with gaps 48 respectively formed between the through-holes 47 and the connection portions 42a, 42b and 42c.

As shown in FIG. 2, each of the through-holes 47 passes through from an inside surface 4a (a surface facing to the housing 2) to an outside surface 4b. Further, each of the through-holes 47 is provided with a taper surface of which the diameter is expanded at an opening formed in the inside surface 4a and an opening formed in the outside surface 4b.

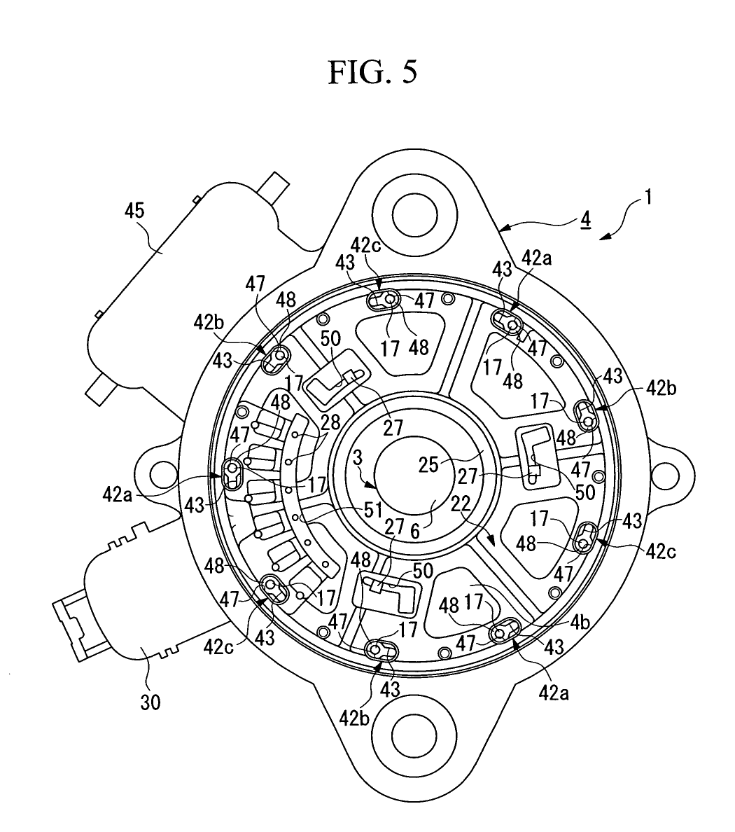

Note that, as shown in FIG. 5, substantially L-shaped grooves 50 and an arc-shaped groove 51 are formed in the outside surface 4b of the bracket 4. The resolver case 27 is engaged with the grooves 50, and thereby is fixed to the bracket 4. The resolver terminals 28 are inserted into the groove 51.

The bracket 4 as mentioned-above is formed by performing the insert molding. For example, pins which support the plate 24 and the three terminals 35, 36 and 37 are formed in a die, and the plate 24 and the three terminals 35, 36 and 37 are respectively set to the pins. The plate 24 and the terminals 35, 36 and 37 are located so as not to electrically contact each other depending on the pins, and thereby displacement of the plate 24 and the terminals 35, 36 and 37 is prevented.

After that, when a resin is cast to the inside of the die and is formed, the bracket 4 is developed such that the plate 24 and the terminals 35, 36 and 37 are inserted within the resin while isolating the plate 24 and the terminals 35, 36 and 37 from each other. Note that, it is preferable that the resin be polyphenylene sulfide (PPS) resin as a thermoplastic crystalline plastic. However, the resin described in this embodiment is not limited to the above-mentioned resin.

Next, assembling work of the brushless motor 1 will be explained.

Firstly, as shown in FIG. 1, the bearing 11 is pressed into the housing 2. Next, the electromagnetic coils 14 which are formed by winding the wires 16 around the cores 15 are disposed inside the housing 2. As described above, the terminal leading lines 17 are pulled out through the opening 2a in advance.

Next, the rotor 3 is inserted into a space formed dividing the inside of the housing 2 with the electromagnetic coils 14 and the other end of the rotation shaft 6 is supported by the bearing 11. Then, the bracket 4 is inserted inside the housing 2 so as to cover the opening 2a, and is fixed to the housing 2 with bolts.

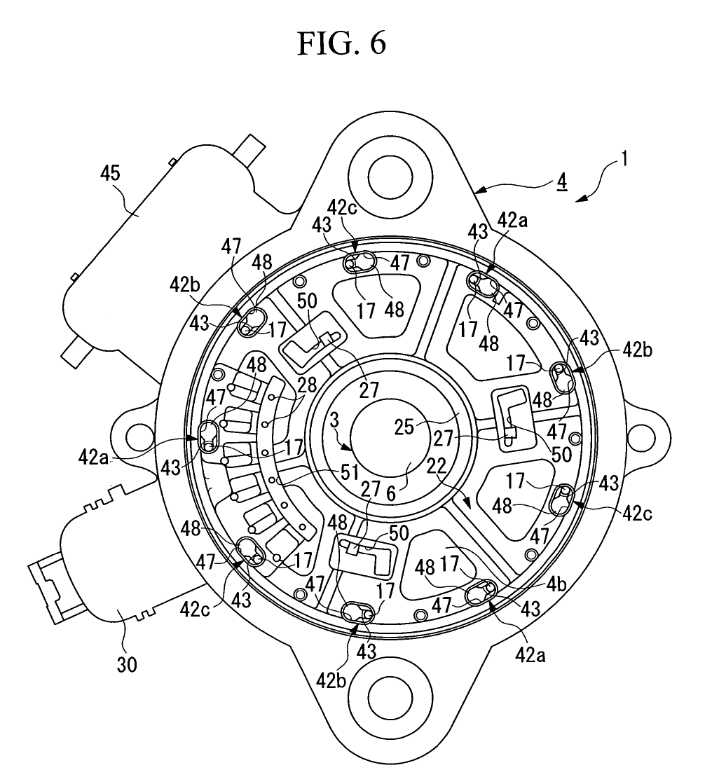

At this time, as shown in FIG. 2 and FIG. 5, the terminal leading lines 17 are respectively inserted into the through-holes 47 formed in the base portion 22 of the bracket 4 from the inside surface 4a of the bracket 4, and then reach to the outside surface 4b of the bracket 4 after respectively passing through the gaps 48. Next, as shown in FIG. 6, the terminal leading lines 17 are respectively inserted into the notches 43 of the connection portions 42a, 42b and 42c by sliding the terminal leading lines 17 in the circumferential direction, and thereby the terminal leading lines 17 are respectively engaged with the notches 43. Further, the terminal leading lines 17 are respectively fixed to the connection portions 42a, 42b and 42c at the outside of the bracket 4 (side of the outside surface 4b). In this case, the terminal leading lines 17 are fixed to the connection portions 42a, 42b and 42c by welding. Note that, sliding and welding of the terminal leading lines 17 can be performed using an automatic machine.

In addition, the length of each of the terminal leading lines 17 is previously set based on the length from the magnetic coil 14 to each of the connection portions 42a, 42b and 42c to which the terminal leading lines 17 are respectively fixed.

When the brushless motor 1 as manufactured above is driven, beforehand the power cable is connected to the coupler 45 integrally-formed with the bracket 4, and a signal line of a control device is connected to the coupler 30

Three-phase alternating current is inputted to the coupler 45 through the power cable, and thereby the current is supplied from the terminal ends 46a, 46b and 46c of the coupler 45 to the terminals 35, 36 and 37. The current is inputted from the connection portions 42a, 42b and 42c to the terminal leading lines 17, and then the magnetic coils 14 are turned on.

As a result, magnetic fluxes are respectively generated at the magnetic coils 14, and thereby the rotor 3 having the magnets 8 rotates. The resolver 9 detects the rotational position of the rotor 3. A signal outputted from the resolver 9 is sent to the coupler 30 through the resolver terminals 28 and the conductive bodies 29 of the bracket 4. Further, the signal is inputted to the control device through the signal line, and is used for three-phase switching control.

According to this embodiment, since the terminals 35, 36 and 37 to which the terminal leading lines 17 of the magnetic coils 14 are respectively connected are inserted within the bracket 4 made of the insulating resin, it is unnecessary to treat the terminal unit including the terminals separately from the bracket. That is, since the terminals 35, 36 and 37 can be treated so as to be integrated with the bracket 4, it is unnecessary to separately locate the terminals 35, 36 and 37 and the bracket 4. As a result, the assembling of the parts becomes easy in an assembling process.

In addition, the stacking structure such that the conductive bodies and the terminals 35, 36 and 37 are alternatively stacked is formed, and thereby it is unnecessary to sandwich each of the terminals between other members. Therefore, it is possible to shorten the length of the brushless motor 1 in the axial direction. Further, since the height of a part in which the terminals 35, 36 and 37 are located (the length along the axial direction) is shortened, the distance from the bearing 11 to the bearing 25 can be shortened. As a result, the precession of the rotor 3 is decreased, and thereby noise is decreased.

In addition, since the terminals 35, 36 and 37 are respectively connected to the terminal leading lines 17 through the elongated through-holes 47 formed in the bracket 4, the terminals 35, 36 and 37 can be connected to the terminal leading lines 17 easily, and thereby the workability is increased. Concretely, the terminal leading line 17 is inserted into the wide gap 48 in the through-hole 47 first. Accordingly, it is easy to pull out the terminal leading line 17 from the bracket 4. Further, since the notches 43 are respectively formed in the connection portions 42a, 42b and 42c along a longitudinal direction of the through-holes 47, it is easy to respectively engage the terminal leading lines 17 with the connection portions 42a, 42b and 42c by only moving the terminal leading lines 17 in the circumferential direction. Furthermore, since the terminal leading lines 17 can be respectively connected to the terminals 35, 36 and 37 at the outside surface 4b of the bracket 4 (that is, the opposite side of the motor) by welding, it is possible to connect the terminal leading lines 17 to the terminals 35, 36 and 37 easily and reliably.

The terminals 35, 36 and 37 respectively have the substantially uniform-shaped main bodies 40a, 40b and 40c. Since the main bodies 40a, 40b and 40c are located along the axial direction, and the connection portions 42a, 42b and 42c which respectively protrude from the main bodies 40a, 40b and 40c are located at intervals along the circumferential direction, it is possible to connect the terminal leading lines 17 to the multiple connection portions 42a, 42b and 42c effectively and reliably.

In addition, since the terminals 35, 36 and 37 are respectively connected to the terminal ends 46a, 46b and 46c of the coupler 45 through the through-holes 47 of the bracket 4 directly, there is no need for providing another conductive body between the terminals 35, 36 and 37 and the coupler 45. Therefore, it is possible to eliminate the process of connecting another conductive body to each of the terminal ends. Further, since there is no need for disposing the conductive body on the outside surface 4b of the bracket 4, the layout of the lines on the bracket 4 becomes simple, and the reliability is increased.

Since the terminals 35, 36 and 37 and the plate 24 made of metal are inserted in the bracket 4 described above, the strength of the bracket 4 is increased.

Note that, it should be understood that these are exemplary of the invention and are not to be considered as limiting, and the present invention can be widely applied without departing from the spirit or scope of the present invention.

For example, the through-holes 47 are not limited to the elongated holes. A gap through which the terminal leading line 17 can be easily passed is just formed between the edge of the through-hole 47 and each of the connection portions 42a, 42b and 42c. Also, the shape of the through-hole 47 may be substantially rectangular or circular.

In addition, each of the connection portions 42a, 42b and 42c may not have the notch 43. In this case, the terminal leading lines 17 may be respectively directly-connected to the connection portions 42a, 42b and 42c by welding. Also, the terminal leading lines 17 may be respectively connected to the connection portions 42a, 42b and 42c by welding after respectively bending the terminal leading lines 17 toward the connection portions 42a, 42b and 42c.

### INDUSTRIAL APPLICABILITY

The present invention relates to a brushless motor including: stators respectively having wires and cores around which the wires are respectively wound; a housing which houses the stators; a rotor rotatably attached to the housing; and a bracket having conductive bodies to which terminal leading lines of the wires are respectively connected and an insulating body supporting the conductive bodies, and installed in an opening of the housing; wherein the conductive bodies are insert-molded to the insulating body. According to the brushless motor of the present invention, since the bracket is manufactured by performing the insert molding of the conductive bodies to which the terminal leading lines of the wires of the magnetic coils are respectively connected to the insulating body, it is possible to simplify the structure of the brushless motor, and it is possible to downsize the brushless motor. Further, by installing the bracket in the housing, the conductive bodies can be located in place, and can be fixed in place. As a result, the assembling of the brushless motor becomes efficient.

What is claimed is:

1. A brushless motor comprising:
stators respectively having wires and cores around which the wires are respectively wound;
a housing which houses the stators;
a rotor rotatably attached to the housing; and
a bracket having conductive bodies to which terminal leading lines of the wires are respectively connected and an insulating body supporting the conductive bodies, and installed in an opening of the housing; wherein
the conductive bodies are insert-molded to the insulating body.

2. The brushless motor according to claim 1, wherein
through-holes which pass through the bracket from the inside surface facing to the housing toward the outside surface facing in the opposite direction of the inside surface are formed in the bracket,
the terminal leading lines are respectively inserted into the through-holes from the inside surface, and
the terminal leading lines are respectively fixed to the conductive bodies at the outside surface of the bracket.

3. The brushless motor according to claim 2, wherein
the through-holes are elongated holes formed so as to be along the circumferential direction of the bracket, and
the conductive bodies are respectively provided with connection portions respectively protruding into the through-holes so as to cover a part of the through-holes.

4. The brushless motor according to claim 3, wherein
notches respectively engaged with the terminal leading lines are respectively formed in the connection portions along the circumferential direction of the bracket.

5. The brushless motor according to claim 1, wherein
the conductive bodies are respectively connected to terminal ends of a coupler for energization extended from a side portion of the bracket.
